(19) United States
(12) Patent Application Publication
(10) Pub. No.: US 2025/0259106 A1
(43) Pub. Date: Aug. 14, 2025

(54) MACHINE LEARNING BASED SYSTEM AND METHOD FOR GENERATING RESPONSES FOR USER INPUTS

(71) Applicant: HIGHRADIUS TECHNOLOGIES PRIVATE LIMITED, HYDERABAD (IN)

(72) Inventors: Sanjeev Suman, Hyderabad (IN); Geetika Tiwari, Hyderabad (IN); Sidharth Gupta, Hyderabad (IN)

(21) Appl. No.: 19/051,501

(22) Filed: Feb. 12, 2025

(30) Foreign Application Priority Data
Feb. 12, 2024 (IN) 202441009310

(51) Int. Cl. G06N 20/00

(52) U.S. Cl. CPC G06N 20/00

(57) ABSTRACT

A ML-based method and system for automatically generating responses to inputs using a multi-tier technique, is disclosed. Initially, first inputs are obtained from electronic devices of first users. An information is retrieved from external sources based on first inputs, using RAG engine. The responses are generated based on optimized information, using ML model. The ML-based method determines whether queries of first users within first inputs are resolved through the optimized responses. Issues are categorized using ML-based issue classification engine when the queries are not resolved. Dynamic forms are generated with fields based on categorization of issues, using a dynamic workflow engine. Second inputs are obtained and processed to determine whether queries are resolved using a rule-based logic engine. The first users are adapted to interact with second users to resolve the issues through communication channels. The responses are provided as output upon resolving the issues, to first users.

### EARLIEST PRIORITY DATE

This application claims priority from a Provisional patent application filed in India having patent application No. 202441009310, filed on Feb. 12, 2024, and titled “MACHINE LEARNING BASED SYSTEMS AND METHODS FOR USER SUPPORT”.

### FIELD OF INVENTION

Embodiments of the present disclosure relate to machine learning based (ML-based) systems, and more particularly relates to a ML-based method and system for generating one or more responses for one or more inputs received from one or more users.

### BACKGROUND

In the field of finance and accounting, software applications have become indispensable tools for businesses seeking to streamline operations, ensure compliance with evolving regulations, and enhance overall productivity. However, while these applications offer several benefits, their effective deployment and utilization are often hampered by significant challenges in user support. These challenges not only diminish user experience but also impede an ability of businesses to leverage software capabilities fully.

A major challenge in the user support for finance and accounting software is the lack of sufficient customization options. Since businesses have distinct processes and reporting needs, the inability to modify software features to align with specific requirements can cause frustration and inefficiencies. Users often struggle to adapt the software to their workflows, leading them to rely on workarounds or settle for limited functionality, ultimately preventing them from making the most of the software's capabilities.

Further, the critical nature of financial operations underscores the importance of timely support. Inadequate response times to user inquiries or issues can have far-reaching consequences, including business disruptions, financial losses, and increased compliance risks. Slow resolution of problems not only exacerbates existing issues but also contributes to a perception of unreliability, undermining the trust in the software provider.

Another major obstacle to effective user support is the skill gap among support staff. Finance and accounting software requires a combination of technical proficiency and financial knowledge, yet support teams often lack expertise in one of these areas. This disconnect hampers efficient problem-solving, resulting in longer resolution times and frustration among users who expect prompt and well-informed assistance. These issues not only impair the user experience but also limit the effectiveness and productivity gains.

Further, conventional user support systems frequently depend on automated responses or extended wait times for human assistance, which can result in user frustration and dissatisfaction. Additionally, a key limitation is their reliance on direct human interaction to resolve issues.

Hence, there is a need for an improved machine learning based (ML-based) system and method for generating one or more responses for one or more inputs provided by one or more users, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) method for automatically generating one or more responses to one or more inputs, is disclosed.

The ML-based method further comprises obtaining, by one or more hardware processors, one or more first inputs from one or more electronic devices associated with one or more first users.

The ML-based method further comprises retrieving, by the one or more hardware processors, one or more information from one or more external sources based on the obtained one or more first inputs, using a retrieval augmented generation (RAG) engine.

The ML-based method further comprises optimizing, by the one or more hardware processors, the one or more information by integrating at least one of: historical data and metadata, into the one or more information, using a machine learning (ML) model.

The ML-based method further comprises generating, by the one or more hardware processors, the one or more responses based on the optimized one or more information, using the ML model. The ML-based method further comprises determining, by the one or more hardware processors, whether one or more queries of the one or more first users within the one or more first inputs are resolved through the optimized one or more responses.

The ML-based method further comprises categorizing, by the one or more hardware processors, one or more issues associated with the one or more queries of the one or more first users using a ML-based issue classification engine, when the one or more queries are not resolved. The ML-based method further comprises generating, by the one or more hardware processors, one or more dynamic forms with one or more fields based on the categorization of the one or more issues associated with the one or more queries of the one or more first users, using a dynamic workflow engine. The ML-based method further comprises obtaining, by the one or more hardware processors, one or more second inputs through the one or more dynamic forms from the one or more electronic devices associated with the one or more first users.

The ML-based method further comprises processing, by the one or more hardware processors, the obtained one or more second inputs to determine whether the one or more queries of the one or more first users are resolved, using a rule-based logic engine. The ML-based method further comprises adapting, by the one or more hardware processors, the one or more first users to interact with one or more second users to resolve the one or more issues associated with the one or more queries of the one or more first users through one or more communication channels. The ML-based method further comprises providing, by the one or more hardware processors, the one or more responses as an output upon resolving the one or more issues, to the one or more first users through the one or more electronic devices associated with the one or more first users.

In an embodiment, the ML-based method further comprises (a) assigning, by the one or more hardware processors, the one or more second users based on at least one of: the categorization of the one or more issues associated with the one or more queries of the one or more first users and an availability of the one or more second users, when the one or more issues associated with the one or more queries of the one or more first users are not resolved; (b) obtaining, by the one or more hardware processors, at least one of: historical process data and one or more contexts comprising the one or more information; (c) monitoring, by the one or more hardware processors, one or more resolution processes comprising resolving of the one or more issues associated with the one or more queries of the one or more first users; (d) updating, by the one or more hardware processors, one or more statues of the one or more processes; and (e) documenting, by the one or more hardware processors, at least one of: one or more interaction details occurred between the one or more first users and the one or more second users on the one or more resolution processes, and one or more details of the one or more resolution processes, for future records.

In another embodiment, retrieving the one or more information using the RAG engine, comprises: (a) obtaining, by one or more hardware processors, the one or more first inputs from the one or more electronic devices associated with the one or more first users; (b) extracting, by the one or more hardware processors, one or more vector representations corresponding to the one or more first inputs, using the RAG engine; (c) comparing, by the one or more hardware processors, the one or more vector representations corresponding to the one or more first inputs, with one or more pre-stored vector representations; and (d) retrieving, by the one or more hardware processors, the one or more information from the one or more external sources, based on the comparison of the one or more vector representations corresponding to the one or more first inputs, with the one or more pre-stored vector representations, using a multi-tenant vector search architecture.

In yet another embodiment, the ML-based method further comprises generating, by the one or more hardware processors, one or more prompts for the ML model for generating the one or more responses, using the optimized one or more information. The one or more prompts comprise one or more fields corresponding to the optimized one or more information, comprising at least one of: a context comprising roles and guidelines of the one or more first users, user information comprising at least one of: name, account identity, and user identity of the one or more first users, one or more instructions comprising one or more rules for formatting and generating the one or more responses, one or more sample details indicating an interaction that demonstrates a desired format, a response format comprising a pre-defined data structure for the output, one or more documents comprising one or more contextually relevant information retrieved from a vector store, and conversation history.

In yet another embodiment, the ML-based method further comprises training, by the one or more hardware processors, the ML model by: (a) obtaining, by the one or more hardware processors, one or more training datasets comprising at least one of: the one or more first inputs and the one or more second inputs, wherein at least one of: the one or more first inputs and the second inputs, comprise one or more queries; (b) training, by the one or more hardware processors, the ML model on the one or more training datasets using one or more training processes comprising at least one of: predicting one or more words next to one or more current words, predicting one or more missing words in one or more sentences, and learning at least one of: syntax, semantics, grammar, and factual knowledge; and (c) generating, by the one or more hardware processors, the one or more responses for at least one of: the one or more first inputs and the one or more second inputs, based on the trained ML model.

In yet another embodiment, the ML-based method further comprises re-training, by the one or more hardware processors, the ML model by: (a) obtaining, by the one or more hardware processors, one or more assessments of the one of more training datasets, from the one or more electronic devices of one or more users; (b) identifying, by the one or more hardware processors, differences between the one or more responses generated by the trained ML model and the one or more assessments obtained from the one or more electronic devices of at least one of: the one or more first users and the one or more second users, to determine whether the ML model need to be optimized on the generation of the one or more responses; and (c) re-training, by the one or more hardware processors, the ML model based on one or more feedback received from the one or more electronic devices of at least one of: the one or more first users and the one or more second users, on the generation of the one or more responses.

In yet another embodiment, the ML-based method further comprises (a) monitoring, by the one or more hardware processors, performance of the ML model for a time duration; (b) determining, by the one or more hardware processors, whether the performance of the ML model on the generation of the one or more responses, is below a threshold value; and (c) fine-tuning, by the one or more hardware processors, the ML model with a plurality of parameters to optimize the ML model for generating the one or more responses.

In yet another embodiment, the ML-based method further comprises (a) generating, by the one or more hardware processors, one or more subsequent queries to be subsequently inputted by the one or more first users, based on the one or more responses generated by the ML model; and (b) recommending, by the one or more hardware processors, the one or more subsequent queries to the one or more electronic devices associated with the one or more first users.

In one aspect, a machine learning based (ML-based) system for automatically generating one or more responses to one or more inputs, is disclosed. The ML-based system includes one or more hardware processors and a memory coupled to the one or more hardware processors. The memory includes a plurality of subsystems in the form of programmable instructions executable by the one or more hardware processors.

The plurality of subsystems comprises an input obtaining subsystem configured to obtain one or more first inputs from one or more electronic devices associated with one or more first users.

The plurality of subsystems further comprises an information retrieving subsystem configured to retrieve one or more information from one or more external sources based on the obtained one or more first inputs, using a retrieval augmented generation (RAG) engine.

The plurality of subsystems further comprises an information optimizing subsystem configured to optimize the one or more information by integrating at least one of: historical data and metadata, into the one or more information, using a machine learning (ML) model.

The plurality of subsystems further comprises a response generating subsystem configured to: (a) generate the one or more responses based on the optimized one or more information, using the ML model; and (b) determine whether one or more queries of the one or more first users within the one or more first inputs are resolved through the optimized one or more responses.

The plurality of subsystems further comprises an issue categorizing subsystem configured to categorize one or more issues associated with the one or more queries of the one or more first users using a ML-based issue classification engine, when the one or more queries are not resolved.

The plurality of subsystems further comprises a forms generating subsystem configured to generate one or more dynamic forms with one or more fields based on the categorization of the one or more issues associated with the one or more queries of the one or more first users, using a dynamic workflow engine. The input obtaining subsystem configured to obtain one or more second inputs through the one or more dynamic forms from the one or more electronic devices associated with the one or more first users.

The plurality of subsystems further comprises an input processing subsystem configured to process the obtained one or more second inputs to determine whether the one or more queries of the one or more first users are resolved, using a rule-based logic engine. The plurality of subsystems further comprises a live support integrating subsystem configured to adapt the one or more first users to interact with one or more second users to resolve the one or more issues associated with the one or more queries of the one or more first users through one or more communication channels. The plurality of subsystems further comprises an output subsystem configured to provide the one or more responses as an output upon resolving the one or more issues, to the one or more first users through the one or more electronic devices associated with the one or more first users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) system for automatically generating one or more responses to one or more inputs, in accordance with an embodiment of the present disclosure;

FIG. 2 is a detailed view of the ML-based system for automatically generating the one or more responses to the one or more inputs, in accordance with another embodiment of the present disclosure;

FIG. 3 is exemplary flow diagram illustrating a tier 1 process for generating the one or more responses to the one or more inputs using a machine learning (ML) model, in accordance with another embodiment of the present disclosure;

FIG. 4 is exemplary flow diagram illustrating a tier 2 process for generating the one or more responses to the one or more inputs using the ML model, in accordance with another embodiment of the present disclosure;

FIG. 5 is exemplary flow diagram illustrating a tier 3 process for generating the one or more responses to the one or more inputs using the ML model, in accordance with another embodiment of the present disclosure; and

FIG. 6 is a flow chart illustrating a machine-learning based (ML-based) method for generating the one or more responses to the one or more inputs, in accordance with an embodiment of the present disclosure;

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

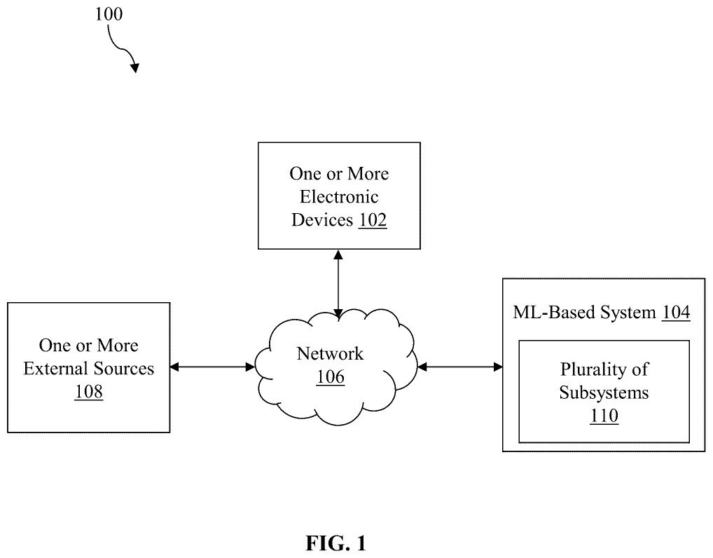

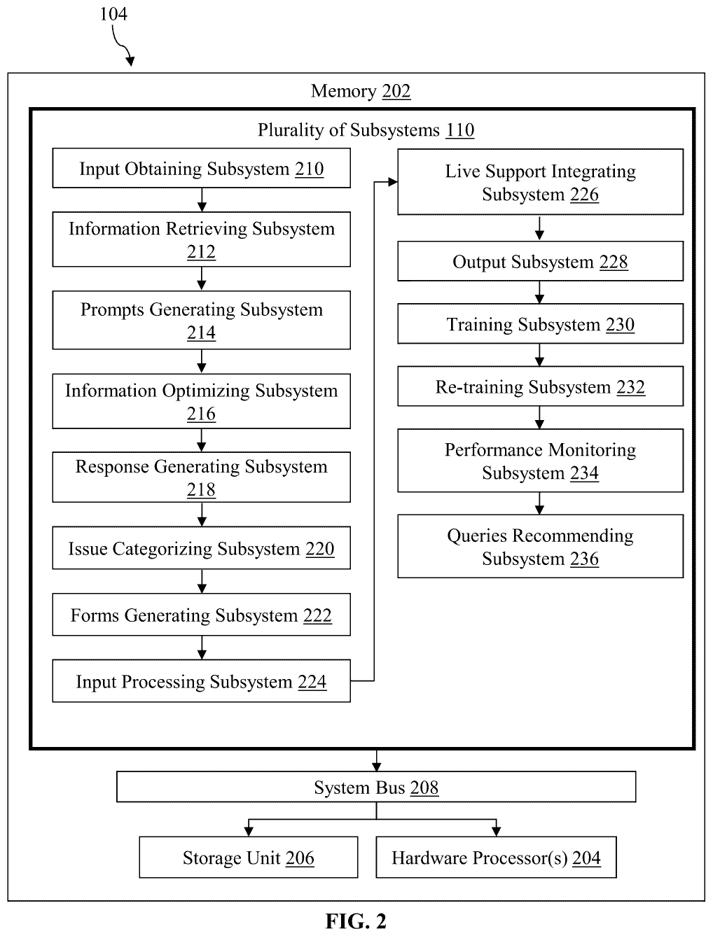

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 is a block diagram illustrating a computing environment 100 with a machine learning based (ML-based) system 104 for automatically generating one or more responses to one or more inputs, in accordance with an embodiment of the present disclosure. According to FIG. 1, the computing environment 100 includes one or more electronic devices 102 that are communicatively coupled to the ML-based system 104 through a network 106. The one or more electronic devices 102 through which one or more end users receive output results from the ML-based system 104.

The present invention is configured to generate one or more responses for the one or more inputs comprising one or more queries provided by the one or more first users. The ML-based system 104 is initially configured to obtain one or more first inputs from one or more electronic devices 102 associated with the one or more first users. In an embodiment, the one or more first inputs may be encrypted and decrypted by the ML-based system 104, so that one or more third party users cannot be authenticated to manipulate the one or more first inputs.

The ML-based system 104 is further configured to retrieve one or more information from one or more external sources 108 based on the obtained one or more first inputs, using a retrieval augmented generation (RAG) engine. The ML-based system 104 is further configured to optimize the one or more information by integrating at least one of: historical data and metadata, into the one or more information, using a machine learning (ML) model.

The ML-based system 104 is further configured to generate the one or more responses based on the optimized one or more information, using the ML model. The ML-based system 104 is further configured to determine whether one or more queries of the one or more first users within the one or more first inputs are resolved through the optimized one or more responses.

The ML-based system 104 is further configured to categorize one or more issues associated with the one or more queries of the one or more first users using a ML-based issue classification engine, when the one or more queries are not resolved. The ML-based system 104 is further configured to generate one or more dynamic forms with one or more fields based on the categorization of the one or more issues associated with the one or more queries of the one or more first users, using a dynamic workflow engine.

The ML-based system 104 is further configured to obtain one or more second inputs through the one or more dynamic forms from the one or more electronic devices 102 associated with the one or more first users. The ML-based system 104 is further configured to process the obtained one or more second inputs to determine whether the one or more queries of the one or more first users are resolved, using a rule-based logic engine.

The ML-based system 104 is further configured to adapt the one or more first users to interact with one or more second users to resolve the one or more issues associated with the one or more queries of the one or more first users through one or more communication channels. The ML-based system 104 is further configured to provide the one or more responses as an output upon resolving the one or more issues, to the one or more first users through the one or more electronic devices 102 associated with the one or more first users.

In an embodiment, the one or more first users may include at least one of: one or more customers, one or more organizations, one or more corporations, one or more parent companies, one or more subsidiaries, one or more joint ventures, one or more partnerships, one or more governmental bodies, one or more associations, and one or more legal entities, and the like. In an embodiment, the one or more second users may include at least one of: one or more data analysts, one or more business analysts, one or more cash analysts, one or more financial analysts, one or more collection analysts, one or more debt collectors, one or more professionals associated with cash and collection management, and the like. In another embodiment, the one or more second users may further include at least one of: customer support agents, executives, technical support teams, and the like.

The ML-based system 104 may be hosted on a central server including at least one of: a cloud server or a remote server. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes the one or more external sources 108 communicatively coupled to the ML-based system 104 through the network 106. In an embodiment, the one or more external sources 108 may store the one or more information related to the one or more responses. In an embodiment, the one or more external sources 108 may be at least one of: one or more relational databases, one or more object-oriented databases, one or more data warehouses, one or more cloud-based databases, and the like. In another embodiment, a format of the one or more information obtained from the one or more external sources 108 may include at least one of: a comma-separated values (CSV) format, a JavaScript Object Notation (JSON) format, an Extensible Markup Language (XML), spreadsheets, and the like.

Furthermore, the one or more electronic devices 102 include at least one of: a local browser, a mobile application, and the like. Furthermore, the one or more first users may use a web application through the local browser, the mobile application to communicate with the ML-based system 104. In an embodiment of the present disclosure, the ML-based system 104 includes a plurality of subsystems 110. Details on the plurality of subsystems 110 have been elaborated in subsequent paragraphs of the present description with reference to FIG. 2.

FIG. 2 is a detailed view of the ML-based system 104 for automatically generating the one or more responses to the one or more inputs, in accordance with another embodiment of the present disclosure. The ML-based system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes an input obtaining subsystem 210, an information retrieving subsystem 212, a prompts generating subsystem 214, an information optimizing subsystem 216, a response generating subsystem 218, an issue categorizing subsystem 220, a forms generating subsystem 222, an input processing subsystem 224, a live support integrating subsystem 226, an output subsystem 228, a training subsystem 230, a re-training subsystem 232, a performance monitoring subsystem 234, and a queries recommending subsystem 236. The brief details of the plurality of subsystems 110 have been elaborated in a below table.

| Plurality of | |
|---|---|
| Subsystems 110 | Functionality |
| Input obtaining | The input obtaining subsystem 210 is configured to obtain the |
| subsystem 210 | one or more first inputs from the one or more electronic devices |
| | 102 associated with the one or more first users. |
| Information | The information retrieving subsystem 212 is configured to |
| retrieving | retrieve the one or more information from the one or more |
| subsystem 212 | external sources 108 based on the obtained one or more first |
| | inputs, using the retrieval augmented generation (RAG) engine. |
| Prompts | The prompts generating subsystem 214 is configured to |
| generating | generate the one or more prompts for the ML model for |
| subsystem 214 | generating the one or more responses, using the optimized one |
| | or more information. |
| Information | The information optimizing subsystem 216 is configured to |
| optimizing | optimize the one or more information by integrating at least one |
| subsystem 216 | of: the historical data and the metadata, into the one or more |
| | information, using the machine learning (ML) model. |
| Response | The response generating subsystem 218 is configured to: (a) |
| generating | generate the one or more responses based on the optimized one |
| subsystem 218 | or more information, using the ML model; and (b) determine |
| | whether one or more queries of the one or more first users |
| | within the one or more first inputs are resolved through the |
| | optimized one or more responses. |
| Issue | The issue categorizing subsystem 220 is configured to |
| categorizing | categorize the one or more issues associated with the one or |
| subsystem 220 | more queries of the one or more first users using the ML-based |
| | issue classification engine, when the one or more queries are |
| | not resolved. |
| Forms | The forms generating subsystem 222 is configured to generate |
| generating | the one or more dynamic forms with the one or more fields |
| subsystem 222 | based on the categorization of the one or more issues associated |
| | with the one or more queries of the one or more first users, using |
| | the dynamic workflow engine |
| Input obtaining | The input obtaining subsystem 210 is configured to obtain the |
| subsystem 210 | one or more second inputs through the one or more dynamic |
| | forms from the one or more electronic devices 102 associated |
| | with the one or more first users. |
| Input | The input processing subsystem 224 is configured to process |
| processing | the obtained one or more second inputs to determine whether |
| subsystem 224 | the one or more queries of the one or more first users are |
| | resolved, using the rule-based logic engine. |
| Live support | The live support integrating subsystem 226 is configured to |
| integrating | adapt the one or more first users to interact with the one or more |
| subsystem 226 | second users to resolve the one or more issues associated with |
| | the one or more queries of the one or more first users through |
| | one or more communication channels. |
| Output | The output subsystem 228 is configured to provide the one or |
| Subsystem 228 | more responses as the output upon resolving the one or more |
| | issues, to the one or more first users through the one or more |
| | electronic devices 102 associated with the one or more first |
| | users. |
| Training | The training subsystem 230 is configured to train the ML model |
| subsystem 230 | using one or more training processes. |
| Re-training | The re-training subsystem 232 is configured to re-train the ML |
| subsystem 232 | model based on one or more feedback received from the one or |
| | more electronic devices 102 of at least one of: the one or more |
| | first users and the one or more second users, on the generation |
| | of the one or more responses. |
| Performance | The performance monitoring subsystem 234 is configured to |
| monitoring | monitor performance of the ML model for a time duration. |
| subsystem 234 | |
| Query | The query recommending subsystem 236 is configured to |
| recommending | recommend one or more subsequent queries to the one or more |
| subsystem 236 | electronic devices 102 associated with the one or more first |
| | users. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the input obtaining subsystem 210 that is communicatively connected to the one or more hardware processors 204. The input obtaining subsystem 210 is configured to obtain the one or more first inputs from the one or more electronic devices 102 associated with the one or more first users. In an embodiment, the one or more first inputs comprise the one or more queries, and one or more instructions, provided by the one or more first users.

In an embodiment, the input obtaining subsystem 210 is configured to obtain the one or more first inputs through a chat interface system of the one or more electronic devices 102 associated with the one or more first users. The chat interface system is configured to facilitate an interactive dialogue between the one or more first users and the ML-based system 104, allowing for clarifications, follow-up questions, and deeper exploration of the generated responses/answers. The chat interface system is further configured to ensure a dynamic and engaging user experience, mimicking the responsiveness and adaptability of the one or more second users.

The plurality of subsystems 110 includes the information retrieving subsystem 212 that is communicatively connected to the one or more hardware processors 204. The information retrieving subsystem 212 is configured to retrieve the one or more information or one or more documents from the one or more external sources 108 based on the obtained one or more first inputs, using the retrieval augmented generation (RAG) engine. For retrieving the one or more information using the RAG engine, the information retrieving subsystem 212 is initially configured to obtain the one or more first inputs from the one or more electronic devices 102 associated with the one or more first users. The information retrieving subsystem 212 is further configured to extract one or more vector representations corresponding to the one or more first inputs, using the RAG engine.

The information retrieving subsystem 212 is further configured to compare the one or more vector representations corresponding to the one or more first inputs, with one or more pre-stored vector representations. The information retrieving subsystem 212 is further configured to retrieve the one or more information from the one or more external sources (e.g., one or more vector stores) 108, based on the comparison of the one or more vector representations corresponding to the one or more first inputs, with the one or more pre-stored vector representations, using a similarity search with a multi-tenant vector search architecture.

In an embodiment, the one or more vector stores complements the traditional database and stores precomputed embedding vectors representing the one or more user queries and relevant data. This enables rapid similarity searches and enhances the system's ability to match user queries with relevant data points and insights. The one or more vector stores play a pivotal role in optimizing the system's performance and accuracy in retrieving answers to the one or more user queries

The multi-tenant vector search architecture is configured to ensures secure and efficient retrieval of the one or more information/documents with product-level indexing, account-level management, and custom OpenSearch vector store extension. The multi-tenant vector search architecture is configured to provide hierarchical indexing and dynamic index resolution for optimal search performance. The multi-tenant vector search architecture is configured to handle searches based on meaning and context.

The information retrieving subsystem 212 is configured to utilize a k-nearest neighbor (KNN) vector engine to create a numerical representation (vector) for each piece of information, capturing its meaning. The information retrieving subsystem 212 is configured to represent the dimension (e.g., 1536) is the number of characteristics used to describe that meaning. The information retrieving subsystem 212 is configured to represent “index.knn” information that is organized to enable quick and easy retrieval of items similar in meaning to a search query.

For example, the multi-tenant vector search architecture is configured to perform “opensearch_vector_store.similarity_search (query=input, k=5, kwargs)”, which is a function used to retrieve the one or more relevant information from the one or more vector stores. The query input may be a search query provided by the one or more first users. The parameter k=5 is a number of top results (most similar items) to be returned. The parameter “kwargs” is additional parameter that may be passed to the function.

The vector store index configuration allows the ML-based system 104 to learn the meaning and context of the information it stores. The vector retrieval process uses this learning/understanding to determine the most relevant results for a given query. This approach goes beyond simple keyword matching and enables more intelligent and context-aware searches.

The algorithm for the multi-tenant vector search architecture in the process of retrieving the one or more information or the one or more documents, is as follows.

```
  # genai/db_router/vector_search.py
class MultiTenantVectorSearch:
  def _{——}init_{——}(self, opensearch_client):
    self.opensearch_client = opensearch_client
  def search(self, query, tenant_id):
    # Perform a multi-tenant vector search
    index = self.get_index_for_tenant(tenant_id)
    results = self.opensearch_client.search(index=index, query=query)
    return results
  def get_index_for_tenant(self, tenant_id):
    # Determine the index based on the tenant ID
    return f“tenant_{tenant_id}_index”
# Usage
vector_search = MultiTenantVectorSearch(opensearch_client)
results = vector_search.search(query, tenant_id)
```

The plurality of subsystems 110 includes the prompt generating subsystem 214 that is communicatively connected to the one or more hardware processors 204. The prompt generating subsystem 214 is configured to generate the one or more prompts for the ML model for generating the one or more responses, using the optimized one or more information.

In an embodiment, the one or more prompts may include one or more fields corresponding to the optimized one or more information, including at least one of: (a) a context comprising roles and guidelines of the one or more first users, (b) user information comprising at least one of: name, account identity, and user identity of the one or more first users, (c) one or more instructions comprising one or more rules for formatting and generating the one or more responses, (d) one or more sample details indicating an interaction that demonstrates a desired format, (e) a response format comprising a pre-defined data structure for the output, (f) one or more documents comprising one or more contextually relevant information retrieved from a vector store, and (g) conversation history.

The plurality of subsystems 110 includes the information optimizing subsystem 216 that is communicatively connected to the one or more hardware processors 204. The information optimizing subsystem 216 is configured to optimize the one or more information by integrating at least one of: historical data and metadata, into the one or more information, using a machine learning (ML) model. The enhanced/optimized one or more information ensures that the one or more responses from the ML model (e.g., a large language model (LLM)) is relevant to the user's current needs and ongoing conversation, taking into account both the specific query and the broader context of the interaction. The information optimizing subsystem 216 is configured to keep tracking of previous interactions with the one or more first users, including past queries and responses. The historical data is used to better understand the context of the one or more first users and to provide one or more personalized responses. In an embodiment, the large language model (LLM) may include at least one of: generative pre-trained transformer version 3 (GPT-3), GPT-3.5, GPT-4, Claude, Bidirectional Encoder Representations from Transformers (BERT), Robustly Optimized BERTa (ROBERTa), Large Language Model Meta AI (LlaMA), and the like

The metadata may include information including at least one of: user profiles, preferences, and session data, which are used to enhance the one or more information (i.e., the context). The metadata may help in tailoring the one or more responses to the specific needs and preferences of the one or more first users. In an embodiment, the information optimizing subsystem 216 is configured to utilize an advanced natural language processing (NLP) model and machine learning models to analyze and integrate the historical data and metadata into the current information.

The algorithm for the information optimizing subsystem 216 in the process of optimizing/enhancing the one or more information, is as follows.

```
  # genai/app.py
class ContextEnhancer:
  def _{——}init_{——}(self, user_history, metadata):
    self.user_history = user_history
    self.metadata = metadata
  def enhance_context(self, query):
    # Combine user history and metadata with the current query
    enhanced_context = {
      “query”: query,
      “history”: self.user_history,
      “metadata”: self.metadata
    }
    return enhanced_context
# Usage
user_history = get_user_history(user_id)
metadata = get_user_metadata(user_id)
context_enhancer = ContextEnhancer(user_history, metadata)
enhanced_context = context_enhancer. Enhance_context(user_query)
```

The plurality of subsystems 110 includes the response generating subsystem 218 that is communicatively connected to the one or more hardware processors 204. The response generating subsystem 218 is configured to generate the one or more responses based on the optimized one or more information, using the ML model. The ML model is trained on large datasets to learn and generate the one or more responses (e.g., one or more human-like responses). In an embodiment, the one or more responses generated by the ML model may be in one or more formats (e.g., JavaScript Object Notation (JSON) format). In an embodiment, the one or more responses generated by the ML model, may be formatted according to one or more provided instructions provided by the one or more first users.

The algorithm for the response generating subsystem 218 in the process of generating the one or more responses to the one or more first inputs, is as follows.

```
  # genai/app.py
class LLMResponseGenerator:
  def _{——}init_{——}(self, llm_model):
    self.llm_model = llm_model
  def generate_response(self, enhanced_context):
    # Generate response using the LLM model
    response = self.llm_model.generate(enhanced_context)
    return response
# Usage
llm_model = load_llm_model( )
response_generator = LLMResponseGenerator(llm_model)
response = response_generator.generate_response(enhanced_context)
```

The plurality of subsystems 110 includes the queries recommending subsystem 236 that is communicatively connected to the one or more hardware processors 204. The queries recommending subsystem 236 is configured to generate the one or more subsequent queries to be subsequently inputted by the one or more first users, based on the one or more responses generated by the ML model. The queries recommending subsystem 236 is further configured to recommend the one or more subsequent queries to the one or more electronic devices 102 associated with the one or more first users.

The response generating subsystem 218 is further configured to determine whether the one or more queries of the one or more first users within the one or more first inputs are resolved through the optimized one or more responses.

The plurality of subsystems 110 includes the issue categorizing subsystem 220 that is communicatively connected to the one or more hardware processors 204. The issue categorizing subsystem 220 is configured to adapt the one or more first users to initiate a support request by filling out forms. The issue categorizing subsystem 220 is further configured to categorize the one or more issues associated with the one or more queries of the one or more first users using the ML-based issue classification engine, when the one or more queries are not resolved. The categorization of the one or more issues may involve one or more processes comprising at least one of: analyzing the one or more first inputs of the one or more first users and determining an appropriate category for the one or more issues associated with the one or more queries of the one or more first users. In an embodiment, the ML-based issue classification engine is configured to utilize a large language model (LLM). The ML-based issue classification engine is further configured to analyze the one or more first input using natural language processing (NLP) techniques to understand nuances, recognize keywords, and comprehend context. Essential features are extracted to aid in the categorization process, guided by a model trained on historical data of past user inputs and queries and their resolutions. This enables the issue categorizing subsystem 220 to identify patterns that inform an appropriate categorization for the issues associated with the one ore first users' inputs and queries.

The plurality of subsystems 110 includes the forms generating subsystem 222 that is communicatively connected to the one or more hardware processors 204. The forms generating subsystem 222 is configured to generate the one or more dynamic forms with the one or more fields based on the categorization of the one or more issues associated with the one or more queries of the one or more first users, using the dynamic workflow engine. In an embodiment, the one or more dynamic forms are configured to adapt the one or more first users to provide the one or more second inputs and to provide guided workflow for collecting additional information.

The algorithms for the issue categorizing subsystem 220 and the forms generating subsystem 222, in the process of categorizing the one or more issues and generating the one or more dynamic forms, respectively, are as follows.

```
  # genai/controller/issue_classifier.py
class IssueClassifier:
  def _{——}init_{——}(self, llm_model):
    self.llm_model = llm_model
  def classify_issue(self, user_input):
    # Classify the issue using the LLM model
    issue_category = self.llm_model.classify(user_input)
    return issue_category
# genai/controller/form_generator.py
class DynamicFormGenerator:
  def _{——}init_{——}(self, issue_category):
    self.issue_category = issue_category
  def generate_form(self):
    # Generate a dynamic form based on the issue category
    form_fields = get_form_fields_for_category(self.issue_category)
    return form_fields
# Usage
issue_classifier = IssueClassifier(llm_model)
issue_category = issue_classifier.classify_issue(user_input)
form_generator = DynamicFormGenerator(issue_category)
dynamic_form = form_generator.generate_form( )
```

In an embodiment, the dynamic workflow engine is configured to manage intelligent form generation and workflow processes. The dynamic workflow engine includes LLM-based issue classification, dynamic field generation, real-time validation, and distributed state management.

The algorithm for the dynamic workflow engine for the above said processes, is as follows.

```
  # genai/controller/workflow_engine.py
class DynamicWorkflowEngine:
  def _{——}init_{——}(self, llm model):
    self.llm_model = llm_model
  def generate_workflow(self, issue_category):
    # Generate a dynamic workflow based on the issue category
    workflow = self.llm_model.generate_workflow(issue_category)
    return workflow
# Usage
workflow_engine = DynamicWorkflowEngine(llm_model)
workflow = workflow_engine.generate_workflow(issue_category)
```

Further, the ML-based system 104 includes an integration architecture configured to integrate the ML-based system 104 with at least one of: multi-tenant vector stores, model-agnostic LLM layers, and multi-channel support. The integration architecture includes real-time synchronization, secure context propagation, and comprehensive monitoring capabilities.

The algorithm for the integration architecture, is as follows.

```
  # genai/integration/integration_hub.py
class IntegrationHub:
  def _{——}init_{——}(self, api_gateway, event_bus, service_mesh):
    self.api_gateway = api_gateway
    self.event_bus = event_bus
    self.service_mesh = service_mesh
  def integrate(self, component):
    # Integrate a new component into the system
    self.api_gateway.register(component)
    self.event_bus.subscribe(component)
    self.service_mesh.add_service(component)
# Usage
integration hub = IntegrationHub(api_gateway,
event_bus, service_mesh)
integration_hub.integrate(new_component)
```

The input obtaining subsystem 210 is further configured to obtain the one or more second inputs through the one or more dynamic forms from the one or more electronic devices 102 associated with the one or more first users.

The plurality of subsystems 110 includes the input processing subsystem 224 that is communicatively connected to the one or more hardware processors 204. The input processing subsystem 224 is configured to process the obtained one or more second inputs to determine whether the one or more queries of the one or more first users are resolved, using a rule-based logic engine.

In an embodiment, the rule-based logic engine is configured to obtain and evaluate these one or more second inputs against a set of predefined rules. For example, the set of predefined rules can be—Rule 1: If the one more second input states “the issue persists despite following troubleshooting steps” the rule-based logic engine might trigger additional automated diagnostic procedures or route the process to tier 3 level i.e., to initiate a live support request. Rule 2: If the one more second input states “restarting the application fixed the issue” then the status of the issue is updated to “resolved”.

The plurality of subsystems 110 includes the live support integrating subsystem 226 that is communicatively connected to the one or more hardware processors 204. The live support integrating subsystem 226 is configured to initiate a live support request when the one or more issues are not resolved. The live support integrating subsystem 226 is further configured to assign the one or more second users based on at least one of: the categorization of the one or more issues associated with the one or more queries of the one or more first users and an availability of the one or more second users, when the one or more issues associated with the one or more queries of the one or more first users are not resolved.

The live support integrating subsystem 226 is further configured to obtain at least one of: historical process data (i.e., complete interaction history) and one or more contexts comprising the one or more information. The live support integrating subsystem 226 is further configured to adapt the one or more first users to interact with the one or more second users to resolve the one or more issues associated with the one or more queries of the one or more first users through the one or more communication channels.

The live support integrating subsystem 226 is further configured to monitor/track one or more resolution processes comprising resolving of the one or more issues associated with the one or more queries of the one or more first users, to update one or more statues of the one or more processes. The live support integrating subsystem 226 is further configured to document at least one of: one or more interaction details occurred between the one or more first users and the one or more second users on the one or more resolution processes, and one or more details of the one or more resolution processes, for future records.

The algorithm for the live support integrating subsystem 226 for enabling the one or more first users to interact with the one or more second users, to resolve the one or more issues and to generate the one or more responses, is as follows.

```
  # genai/controller/live_support.py
class LiveSupport:
  def _{——}init_{——}(self, agent_manager):
    self.agent_manager = agent_manager
  def assign_agent(self, issue_category):
    # Assign a support agent based on the issue category
    agent = self.agent_manager.get_available_agent(issue_category)
    return agent
  def transfer_context(self, agent, context):
    # Transfer the complete interaction history
    and context to the support agent
    agent.receive_context(context)
# Usage
live_support = LiveSupport(agent_manager)
agent = live_support.assign_agent(issue_category)
live_support.transfer_context(agent, enhanced_context)
```

In an embodiment, the overall system architecture includes RAG-enhanced chat support configured to manage initial user queries with document retrieval and context enhancement. The overall system architecture further includes guided support workflow configured to manage issue classification, dynamic form generation, and automated processing. The overall system architecture further includes live support integration configured to provide real-time interaction with support agents and context transfer. The overall system architecture further includes vector search engine configured to implement multi-tenant vector search with dynamic index resolution.

The overall system architecture further includes workflow manager configured to manage form generation, rule-based routing, and state management. The overall system architecture further includes integration hub configured to facilitate secure API gateway, event bus, and service mesh for real-time updates and logging. The overall system architecture further includes agent system configured to manage factory-based agent creation and specialized implementations. The overall system architecture further includes frontend state management configured to manage centralized form processing and value preservation.

ensures efficient, accurate, and secure support experiences across multiple tiers and components. The algorithm for the overall system architecture, is as follows.

```
  # genai/system_architecture.py
class SystemArchitecture:
  def _{——}init_{——}(self):
    self.rag_chat_support = RAGChatSupport( )
    self.guided_support_workflow = GuidedSupportWorkflow( )
    self.live_support_integration = LiveSupportIntegration( )
    self.vector_search_engine = VectorSearchEngine( )
    self.workflow_manager = Workflow Manager( )
    self.integration_hub = IntegrationHub( )
    self.agent_system = AgentSystem( )
    self.frontend_state_management = FrontendStateManagement( )
  def initialize_system(self):
    # Initialize all system components
    self.rag_chat_support.initialize( )
    self.guided_support_workflow.initialize( )
    self.live_support_integration.initialize( )
    self.vector_search_engine.initialize( )
    self.workflow_manager.initialize( )
    self.integration_hub.initialize( )
    self.agent_system.initialize( )
    self.frontend_state_management.initialize( )
# Usage
system_architecture = SystemArchitecture( )
system_architecture.initialize_system( )
```

The plurality of subsystems 110 includes the output subsystem 228 that is communicatively connected to the one or more hardware processors 204. The output subsystem 228 is configured to provide the one or more responses as the output upon resolving the one or more issues, to the one or more first users through the one or more electronic devices 102 associated with the one or more first users. In an embodiment, the one or more responses generated by the ML model may be in one or more formats (e.g., JavaScript Object Notation (JSON) format). In an embodiment, the one or more responses generated by the ML model, may be formatted according to one or more provided instructions provided by the one or more first users.

The plurality of subsystems 110 includes the training subsystem 230 that is communicatively connected to the one or more hardware processors 204. The training subsystem 230 is configured to train the ML model. For training the ML model, the training subsystem 230 is initially configured to obtain one or more training datasets comprising at least one of: the one or more first inputs and the one or more second inputs, In an embodiment, at least one of: the one or more first inputs and the second inputs, comprise at least one of: the one or more queries, and the one or more instructions.

The training subsystem 230 is further configured to train the ML model on the one or more training datasets using one or more training processes comprising at least one of: predicting one or more words next to one or more current words, predicting one or more missing words in one or more sentences, and learning at least one of: syntax, semantics, grammar, and factual knowledge. The training subsystem 230 is further configured to generate the one or more responses for at least one of: the one or more first inputs and the one or more second inputs, based on the trained ML model.

The plurality of subsystems 110 includes the re-training subsystem 232 that is communicatively connected to the one or more hardware processors 204. The re-training subsystem 232 is configured to re-train the ML model. For re-training the ML model, the re-training subsystem 232 is initially configured to obtain one or more assessments of the one of more training datasets, from the one or more electronic devices 102 of one or more users.

The re-training subsystem 232 is further configured to identify differences between the one or more responses generated by the trained ML model and the one or more assessments obtained from the one or more electronic devices 102 of at least one of: the one or more first users and the one or more second users, to determine whether the ML model need to be optimized on the generation of the one or more responses. The re-training subsystem 232 is further configured to re-train the ML model based on one or more feedback received from the one or more electronic devices 102 of at least one of: the one or more first users and the one or more second users, on the generation of the one or more responses.

In one embodiment, to ensure that confidential information belonging to the one or more first users is not misused during the training and retraining of the machine learning model, a number of robust data isolation and privacy protection measures are implemented within the training subsystem 230 and re-training subsystem 232. First, the training datasets undergo stringent anonymization processes, wherein any personally identifiable information (PII), business-sensitive data, financial records, and high-risk data are thoroughly removed or masked prior to being utilized in the training or re-training of the ML model. The training data is then aggregated to eliminate any individual user context, thereby minimizing the risk of exposing specific user information throughout the training process. The overall system architecture employs a multi-tenant architecture for vector search, ensuring that training data remains segregated for each tenant or user. By dynamically selecting the appropriate index, the training data is stored and searched based on account-specific parameters, thus preventing any cross-tenant data mixing. Each account benefits from independent management, maintaining a clear separation between the information of different users. This enhances security for confidential information while simplifying access controls and audit trails. Access controls are further enforced to restrict who can view or modify the training datasets. Role-based access control mechanisms ensure that only authorized personnel can access sensitive information, thus protecting it from unauthorized exposure. Additionally, data provenance tracking is integrated, allowing for comprehensive monitoring and auditing of the training data usage throughout the lifecycle. This capability is essential for compliance with data protection regulations and fosters accountability in data handling. In another embodiment, during the re-training process, the re-training subsystem 232 is configured to utilize only aggregated feedback that remains disconnected from individual users. Feedback from users (i.e., the one or more first users and the one or more second users) concerning generated responses is analysed to identify systemic issues and opportunities for optimization while preserving user confidentiality. No user-specific data is retained or utilized in a manner that could result in cross-user information leakage. Moreover, PII is systematically anonymized even if historical interaction data is employed for improving model performance, ensuring that no direct or reversible mapping to specific users remains in the processed datasets. By implementing this multi-layered approach-combining anonymization, access controls, data segregation through a multi-tenant architecture, data provenance, and meticulous feedback management—the system guarantees the protection of confidential information and prevents inadvertent disclosures during the training of the model. This comprehensive strategy significantly enhances the overall safety and integrity of the training and re-training processes of the ML model.

The plurality of subsystems 110 includes the performance monitoring subsystem 234 that is communicatively connected to the one or more hardware processors 204. The performance monitoring subsystem 234 is configured to monitor performance of the ML model for a time duration. The performance monitoring subsystem 234 is further configured to determine whether the performance of the ML model on the generation of the one or more responses, is below a threshold value. The performance monitoring subsystem 234 is further configured to fine-tune the ML model with a plurality of parameters to optimize the ML model for generating the one or more responses.

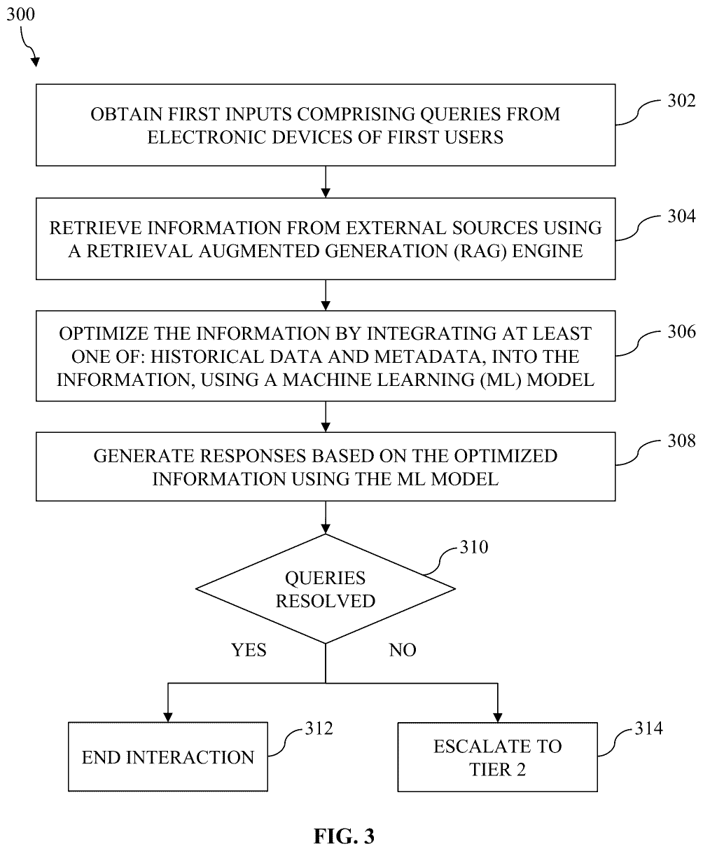

FIG. 3 is exemplary flow diagram 300 illustrating a tier 1 process for generating the one or more responses to the one or more inputs using the ML model, in accordance with another embodiment of the present disclosure. At step 302, the one or more first inputs are obtained from the one or more electronic devices 102 associated with the one or more first users. At step 304, the one or more information (i.e., the one or more contextual information) is retrieved from the one or more external sources 108 using the RAG engine.

At step 306, the one or more information is optimized by integrating at least one of: the historical data and the metadata, into the one or more information, using the ML model.

At step 308, the one or more responses are generated based on the optimized one or more information, using the ML model.

At step 310, the ML-based system 104 determines whether one or more queries of the one or more first users within the one or more first inputs are resolved through the optimized one or more responses. If the one or more queries are resolved, then the interaction process stops at step 312. If the one or more queries are not resolved, then the ML-based system 104 escalates the process to tier 2 level.

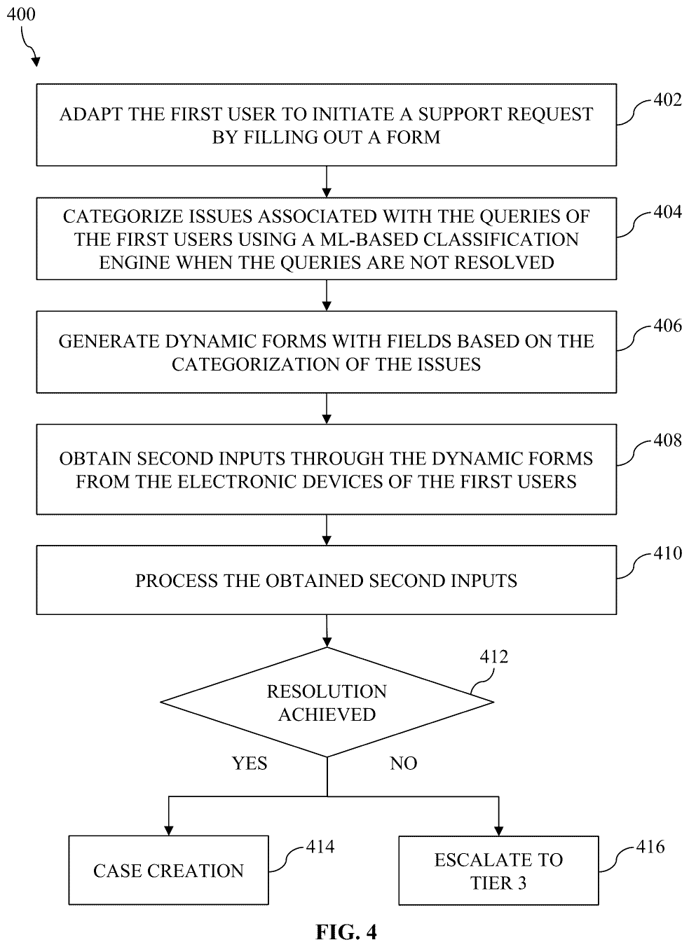

FIG. 4 is exemplary flow diagram 400 illustrating a tier 2 process for generating the one or more responses to the one or more inputs using the ML model, in accordance with another embodiment of the present disclosure. At step 402, the one or more first users are adapted to initiate a support request by filling out the forms. At step 404, the one or more issues associated with the one or more queries of the one or more first users, are categorized using the ML-based issue classification engine, when the one or more queries are not resolved.

At step 406, the one or more dynamic forms with one or more fields are generated based on the categorization of the one or more issues associated with the one or more queries of the one or more first users, using the dynamic workflow engine. At step 408, the one or more second inputs are obtained through the one or more dynamic forms from the one or more electronic devices 102 associated with the one or more first users.

At step 410, the obtained one or more second inputs are processed to determine whether the one or more queries of the one or more first users are resolved, using the rule-based logic engine. At step 412, the ML-based system 104 determines whether the one or more issues are resolved. If the one or more issues are resolved, then the case is created, as shown in step 414. If the one or more issues are not resolved, then the ML-based system 104 escalates the process to tier 3 level.

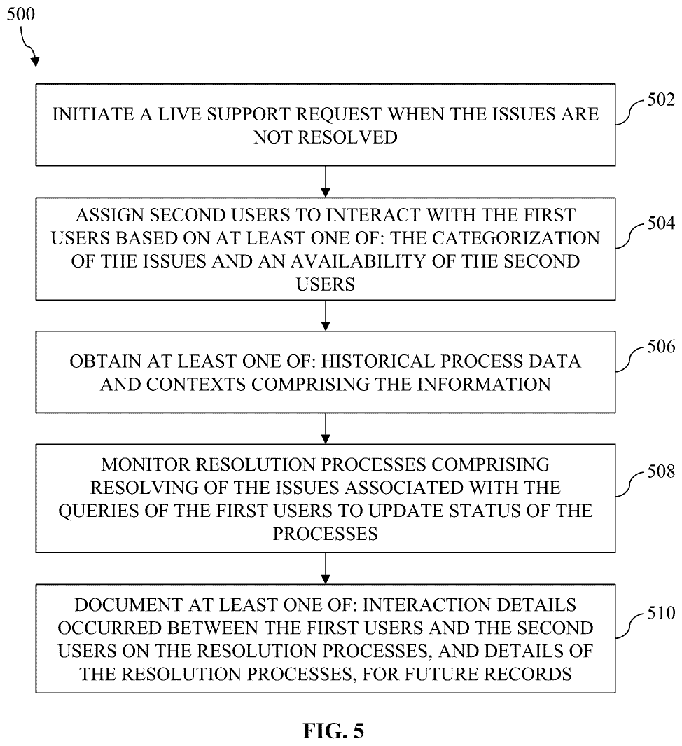

FIG. 5 is exemplary flow diagram 500 illustrating a tier 3 process for generating the one or more responses to the one or more inputs using the ML model, in accordance with another embodiment of the present disclosure. At step 502, the live support request is initiated when the one or more issues are not resolved. At step 504, the one or more second users are assigned based on at least one of: the categorization of the one or more issues associated with the one or more queries of the one or more first users and an availability of the one or more second users, when the one or more issues associated with the one or more queries of the one or more first users are not resolved.

At step 506, at least one of: the historical process data and the one or more contexts comprising the one or more information, are obtained. At step 508, the one or more resolution processes comprising resolving of the one or more issues associated with the one or more queries of the one or more first users, is monitored to update the one or more statues of the one or more processes. At step 510, at least one of: the one or more interaction details occurred between the one or more first users and the one or more second users on the one or more resolution processes, and one or more details of the one or more resolution processes, are documented for future records.

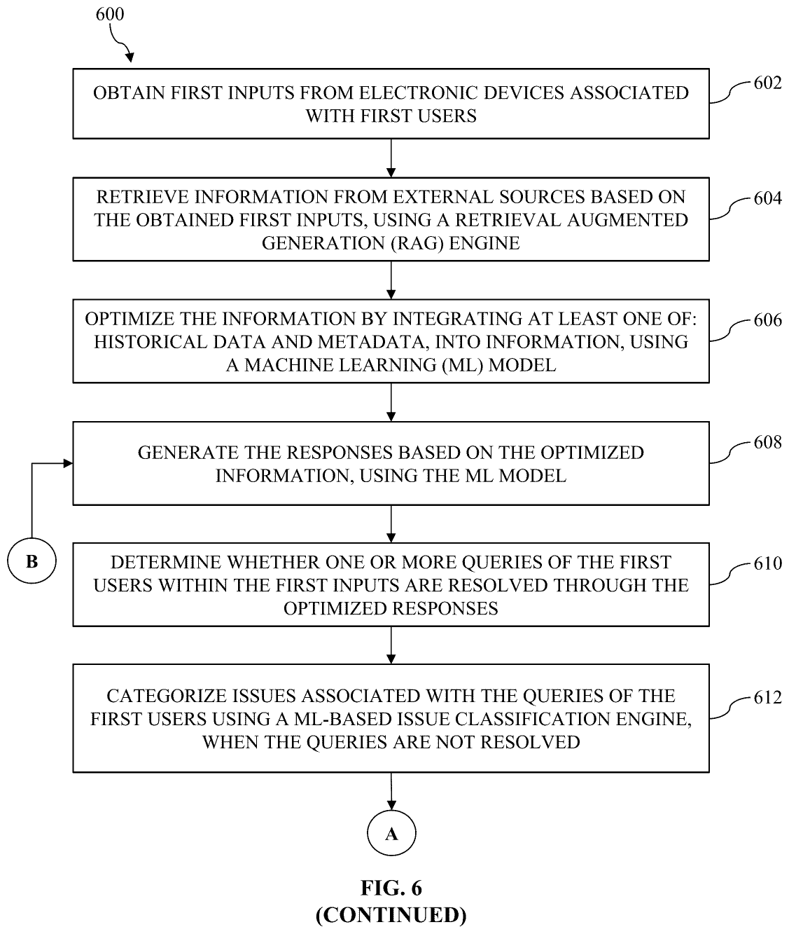

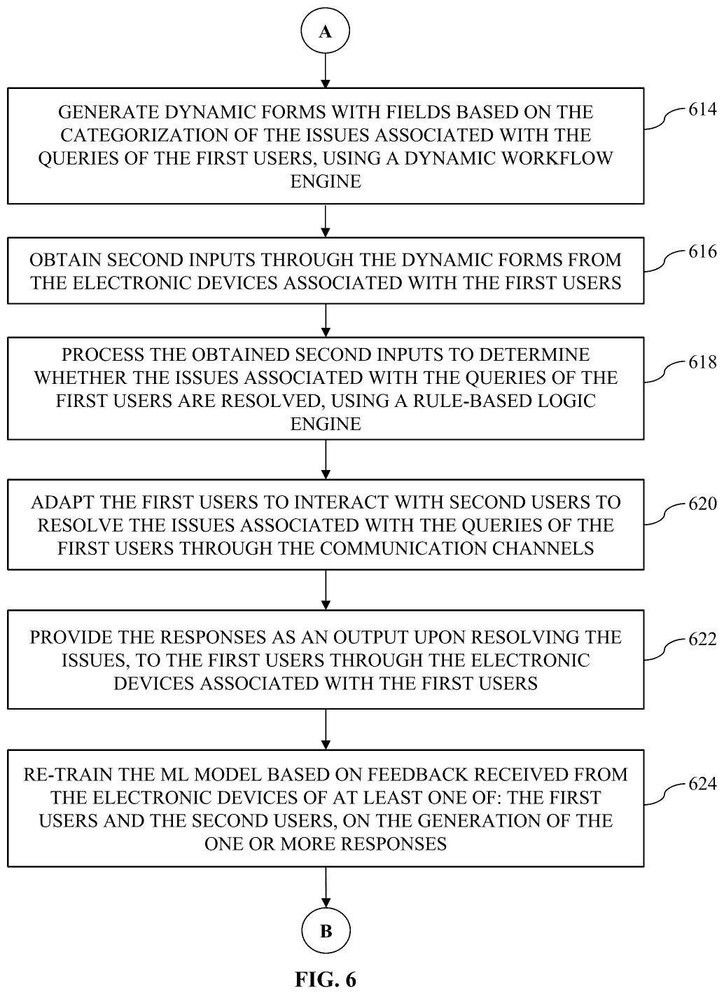

FIG. 6 is a flow chart illustrating a machine-learning based (ML-based) method 600 for automatically generating the one or more responses to the one or more inputs, in accordance with an embodiment of the present disclosure.

At step 602, the one or more first inputs are obtained from the one or more electronic devices 102 associated with the one or more first users.

At step 604, the one or more information is retrieved from the one or more external sources 108 based on the obtained one or more first inputs, using the retrieval augmented generation (RAG) engine.

At step 606, the one or more information is optimized by integrating at least one of: historical data and metadata, into information, using a machine learning (ml) model.

At step 608, the one or more responses are generated based on the optimized one or more information, using the ML model.

At step 610, the ML-based system 104 determines whether one or more queries of the one or more first users within the one or more first inputs are resolved through the optimized one or more responses.

At step 612, the one or more issues associated with the one or more queries of the one or more first users are categorized using the ML-based issue classification engine, when the one or more queries are not resolved.

At step 614, the one or more dynamic forms with one or more fields are generated based on the categorization of the one or more issues associated with the one or more queries of the one or more first users, using the dynamic workflow engine.

At step 616, the one or more second inputs are obtained through the one or more dynamic forms from the one or more electronic devices 102 associated with the one or more first users.

At step 618, the obtained one or more second inputs are processed to determine whether the one or more queries of the one or more first users are resolved, using the rule-based logic engine.

At step 620, the one or more first users are adapted to interact with the one or more second users to resolve the one or more issues associated with the one or more queries of the one or more first users through one or more communication channels.

At step 622, the one or more responses are provided as the output upon resolving the one or more issues, to the one or more first users through the one or more electronic devices 102 associated with the one or more first users.

At step 624, the ML model is re-trained based on the one or more feedback received from the one or more electronic devices 102 of at least one of: the one or more first users and the one or more second users, on the generation of the one or more responses.

The present invention has following advantages. The primary purpose of the present invention with the ML-based system 104 is to automatically generate the one or more responses to the one or more inputs. The present invention with the ML-based system 104 is configured to provide enhanced efficiency in one or more processes comprising at least one of: intelligent routing and automated responses, dynamic form generation and validation, resource allocation based on complexity, content preservation, dynamic breaching, and parallel processing. The present invention with the ML-based system 104 is configured to provide improved accuracy in at least one of: context-aware responses, rule-based verification, learning capabilities, automated validation, historical pattern recognition, data-driven escalation.

The present invention with the ML-based system 104 is configured to provide scalability in at least one of: high concurrency support, multi-tenant isolation, intelligent load balancing, horizontal scaling, flexible deployment, and dynamic capacity adjustment. The present invention with the ML-based system 104 is configured to provide enhanced/optimized user experience in at least one of: seamless tier transitions, cross-channel consistency, personalized responses, progressive disclosure, real-time feedback, and multi-channel support.

The present invention with the ML-based system 104 is configured to provide operation benefits such as reduced support costs, improved productivity, better resource utilization, knowledge retention, automated documentation, and real-time analytics. The present invention with the ML-based system 104 is configured to provide secure and compliance in multi-level security, tenant isolation, audit logging, access controls, data encryption, and compliance monitoring.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 104 either directly or through intervening I/O controllers. Network adapters may also be coupled to the ML-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 104 in accordance with the embodiments herein. The ML-based system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 104. The ML-based system 104 can read the inventive instructions on the program storage devices and follow these instructions to execute the methodology of the embodiments herein.

The ML-based system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) method for automatically generating one or more responses to one or more inputs, the ML-based method comprising:
obtaining, by one or more hardware processors, one or more first inputs from one or more electronic devices associated with one or more first users;
retrieving, by the one or more hardware processors, one or more information from one or more external sources based on the obtained one or more first inputs, using a retrieval augmented generation (RAG) engine;
optimizing, by the one or more hardware processors, the one or more information by integrating at least one of: historical data and metadata, into the one or more information, using a machine learning (ML) model;
generating, by the one or more hardware processors, the one or more responses based on the optimized one or more information, using the ML model;
determining, by the one or more hardware processors, whether one or more queries of the one or more first users within the one or more first inputs are resolved through the optimized one or more responses s;
categorizing, by the one or more hardware processors, one or more issues associated with the one or more queries of the one or more first users using a ML-based issue classification engine, when the one or more queries are not resolved;
generating, by the one or more hardware processors, one or more dynamic forms with one or more fields based on the categorization of the one or more issues associated with the one or more queries of the one or more first users, using a dynamic workflow engine;
obtaining, by the one or more hardware processors, one or more second inputs through the one or more dynamic forms from the one or more electronic devices associated with the one or more first users;
processing, by the one or more hardware processors, the obtained one or more second inputs to determine whether the one or more queries of the one or more first users are resolved, using a rule-based logic engine;
adapting, by the one or more hardware processors, the one or more first users to interact with one or more second users to resolve the one or more issues associated with the one or more queries of the one or more first users through one or more communication channels; and
providing, by the one or more hardware processors, the one or more responses as an output upon resolving the one or more issues, to the one or more first users through the one or more electronic devices associated with the one or more first users.

2. The ML-based method of claim 1, further comprising:
assigning, by the one or more hardware processors, the one or more second users based on at least one of: the categorization of the one or more issues associated with the one or more queries of the one or more first users and an availability of the one or more second users, when the one or more issues associated with the one or more queries of the one or more first users are not resolved;
obtaining, by the one or more hardware processors, at least one of: historical process data and one or more contexts comprising the one or more information;
monitoring, by the one or more hardware processors, one or more resolution processes comprising resolving of the one or more issues associated with the one or more queries of the one or more first users;
updating, by the one or more hardware processors, one or more statues of the one or more processes; and
documenting, by the one or more hardware processors, at least one of: one or more interaction details occurred between the one or more first users and the one or more second users on the one or more resolution processes, and one or more details of the one or more resolution processes, for future records.

3. The ML-based method of claim 1, wherein retrieving the one or more information using the RAG engine, comprises:
obtaining, by one or more hardware processors, the one or more first inputs from the one or more electronic devices associated with the one or more first users;
extracting, by the one or more hardware processors, one or more vector representations corresponding to the one or more first inputs, using the RAG engine;
comparing, by the one or more hardware processors, the one or more vector representations corresponding to the one or more first inputs, with one or more pre-stored vector representations; and
retrieving, by the one or more hardware processors, the one or more information from the one or more external sources, based on the comparison of the one or more vector representations corresponding to the one or more first inputs, with the one or more pre-stored vector representations, using a multi-tenant vector search architecture.

4. The ML-based method of claim 1, further comprising generating, by the one or more hardware processors, one or more prompts for the ML model for generating the one or more responses, using the optimized one or more information,
wherein the one or more prompts comprise one or more fields corresponding to the optimized one or more information, comprising at least one of: a context comprising roles and guidelines of the one or more first users, user information comprising at least one of: name, account identity, and user identity of the one or more first users, one or more instructions comprising one or more rules for formatting and generating the one or more responses, one or more sample details indicating an interaction that demonstrates a desired format, a response format comprising a pre-defined data structure for the output, one or more documents comprising one or more contextually relevant information retrieved from a vector store, and conversation history.

5. The ML-based method of claim 1, further comprising training, by the one or more hardware processors, the ML model by:
obtaining, by the one or more hardware processors, one or more training datasets comprising at least one of: the one or more first inputs and the one or more second inputs, wherein at least one of: the one or more first inputs and the second inputs, comprise one or more queries;
training, by the one or more hardware processors, the ML model on the one or more training datasets using one or more training processes comprising at least one of: predicting one or more words next to one or more current words, predicting one or more missing words in one or more sentences, and learning at least one of: syntax, semantics, grammar, and factual knowledge; and
generating, by the one or more hardware processors, the one or more responses for at least one of: the one or more first inputs and the one or more second inputs, based on the trained ML model.

6. The ML-based method of claim 5, further comprising re-training, by the one or more hardware processors, the ML model by:
obtaining, by the one or more hardware processors, one or more assessments of the one of more training datasets, from the one or more electronic devices of one or more users;
identifying, by the one or more hardware processors, differences between the one or more responses generated by the trained ML model and the one or more assessments obtained from the one or more electronic devices of at least one of: the one or more first users and the one or more second users, to determine whether the ML model need to be optimized on the generation of the one or more responses; and
re-training, by the one or more hardware processors, the ML model based on one or more feedback received from the one or more electronic devices of at least one of: the one or more first users and the one or more second users, on the generation of the one or more responses.

7. The ML-based method of claim 1, further comprising:
monitoring, by the one or more hardware processors, performance of the ML model for a time duration;
determining, by the one or more hardware processors, whether the performance of the ML model on the generation of the one or more responses, is below a threshold value; and
fine-tuning, by the one or more hardware processors, the ML model with a plurality of parameters to optimize the ML model for generating the one or more responses.

8. The ML-based method of claim 1, further comprising:
generating, by the one or more hardware processors, one or more subsequent queries to be subsequently inputted by the one or more first users, based on the one or more responses generated by the ML model; and
recommending, by the one or more hardware processors, the one or more subsequent queries to the one or more electronic devices associated with the one or more first users.

9. A machine learning based (ML-based) system for automatically generating one or more responses to one or more inputs, the ML-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an input obtaining subsystem configured to obtain one or more first inputs from one or more electronic devices associated with one or more first users;
an information retrieving subsystem configured to retrieve one or more information from one or more external sources based on the obtained one or more first inputs, using a retrieval augmented generation (RAG) engine;
an information optimizing subsystem configured to optimize the one or more information by integrating at least one of: historical data and metadata, into the one or more information, using a machine learning (ML) model;
a response generating subsystem configured to:
generate the one or more responses based on the optimized one or more information, using the ML model; and
determine whether one or more queries of the one or more first users within the one or more first inputs are resolved through the optimized one or more responses;
an issue categorizing subsystem configured to categorize one or more issues associated with the one or more queries associated with the one or more queries of the one or more first users using a ML-based issue classification engine, when the one or more queries are not resolved;
a forms generating subsystem configured to generate one or more dynamic forms with one or more fields based on the categorization of the one or more issues associated with the one or more queries of the one or more first users, using a dynamic workflow engine;
the input obtaining subsystem configured to obtain one or more second inputs through the one or more dynamic forms from the one or more electronic devices associated with the one or more first users;
an input processing subsystem configured to process the obtained one or more second inputs to determine whether the one or more queries of the one or more first users are resolved, using a rule-based logic engine;
a live support integrating subsystem configured to adapt the one or more first users to interact with one or more second users to resolve the one or more issues associated with the one or more queries of the one or more first users through one or more communication channels; and
an output subsystem configured to provide the one or more responses as an output upon resolving the one or more issues, to the one or more first users through the one or more electronic devices associated with the one or more first users.

10. The ML-based system of claim 9, wherein the live support integrating subsystem is further configured to:
assign the one or more second users based on at least one of: the categorization of the one or more issues associated with the one or more queries of the one or more first users and an availability of the one or more second users, when the one or more issues associated with the one or more queries of the one or more first users are not resolved;
obtain at least one of: historical process data and one or more contexts comprising the one or more information;
monitor one or more resolution processes comprising resolving of the one or more issues associated with the one or more queries of the one or more first users;
update one or more statues of the one or more processes; and
document at least one of: one or more interaction details occurred between the one or more first users and the one or more second users on the one or more resolution processes, and one or more details of the one or more resolution processes, for future records.

11. The ML-based system of claim 9, wherein in retrieving the one or more information using the RAG engine, the information retrieving subsystem is configured to:
obtain the one or more first inputs from the one or more electronic devices associated with the one or more first users;
extract one or more vector representations corresponding to the one or more first inputs, using the RAG engine;
compare the one or more vector representations corresponding to the one or more first inputs, with one or more pre-stored vector representations; and
retrieve the one or more information from the one or more external sources, based on the comparison of the one or more vector representations corresponding to the one or more first inputs, with the one or more pre-stored vector representations, using a multi-tenant vector search architecture.

12. The ML-based system of claim 9, further comprising a prompts generating subsystem configured to generate one or more prompts for the ML model for generating the one or more responses, using the optimized one or more information,
wherein the one or more prompts comprise one or more fields corresponding to the optimized one or more information, comprising at least one of: a context comprising roles and guidelines of the one or more first users, user information comprising at least one of: name, account identity, and user identity of the one or more first users, one or more instructions comprising one or more rules for formatting and generating the one or more responses, one or more sample details indicating an interaction that demonstrates a desired format, a response format comprising a pre-defined data structure for the output, one or more documents comprising one or more contextually relevant information retrieved from a vector store, and conversation history.

13. The ML-based system of claim 9, further comprising a training subsystem configured to train the ML model, by:
obtaining one or more training datasets comprising at least one of: the one or more first inputs and the one or more second inputs, wherein at least one of: the one or more first inputs and the second inputs, comprise one or more queries;
training the ML model on the one or more training datasets using one or more training processes comprising at least one of: predicting one or more words next to one or more current words, predicting one or more missing words in one or more sentences, and learning at least one of: syntax, semantics, grammar, and factual knowledge; and
generating the one or more responses for at least one of: the one or more first inputs and the one or more second inputs, based on the trained ML model.

14. The ML-based system of claim 13, further comprising a re-training subsystem configured to re-train the ML model, by:
obtaining one or more assessments of the one of more training datasets, from the one or more electronic devices of the one or more users;
identifying differences between the one or more responses generated by the trained ML model and the one or more assessments obtained from the one or more electronic devices of at least one of: the one or more first users and the one or more second users, to determine whether the ML model need to be optimized on the generation of the one or more responses; and
re-training the ML model based on one or more feedback received from the one or more electronic devices of at least one of: the one or more first users and the one or more second users, on the generation of the one or more responses.

15. The ML-based system of claim 9, further comprising a performance monitoring subsystem configured to:
monitor performance of the ML model for a time duration;
determine whether the performance of the ML model on the generation of the one or more responses, is below a threshold value; and
fine-tune the ML model with a plurality of parameters to optimize the ML model for generating the one or more responses.

16. The ML-based system of claim 13, further comprising a queries recommending subsystem configured to:
generate one or more subsequent queries to be subsequently inputted by the one or more first users, based on the one or more responses generated by the ML model; and
recommend the one or more subsequent queries to the one or more electronic devices associated with the one or more first users.

17. A non-transitory computer-readable storage medium having instructions stored therein that when executed by one or more hardware processors, cause the one or more hardware processors to execute operations of:
obtaining one or more first inputs from one or more electronic devices associated with one or more first users;
retrieving one or more information from one or more external sources based on the obtained one or more first inputs, using a retrieval augmented generation (RAG) engine;
optimizing the one or more information by integrating at least one of: historical data and metadata, into the one or more information, using a machine learning (ML) model;
generating the one or more responses based on the optimized one or more information, using the ML model;
determining whether one or more queries of the one or more first users within the one or more first inputs are resolved through the optimized one or more responses;
categorizing one or more issues associated with the one or more queries of the one or more first users using a ML-based issue classification engine when the one or more queries are not resolved;
generating one or more dynamic forms with one or more fields based on the categorization of the one or more issues associated with the one or more queries of the one or more first users, using a dynamic workflow engine;
obtaining one or more second inputs through the one or more dynamic forms from the one or more electronic devices associated with the one or more first users;
processing the obtained one or more second inputs to determine whether the one or more queries of the one or more first users are resolved, using a rule-based logic engine;
adapting the one or more first users to interact with one or more second users to resolve the one or more issues associated with the one or more queries of the one or more first users through one or more communication channels; and
providing the one or more responses as an output upon resolving the one or more issues, to the one or more first users through the one or more electronic devices associated with the one or more first users.

18. The non-transitory computer-readable storage medium of claim 17, further comprising:
assigning the one or more second users based on at least one of: the categorization of the one or more issues associated with the one or more queries of the one or more first users and an availability of the one or more second users, when the one or more issues associated with the one or more queries of the one or more first users are not resolved;
obtaining at least one of: historical process data and one or more contexts comprising the one or more information;
monitoring one or more resolution processes comprising resolving of the one or more issues associated with the one or more queries of the one or more first users;
updating one or more statues of the one or more processes; and
documenting at least one of: one or more interaction details occurred between the one or more first users and the one or more second users on the one or more resolution processes, and one or more details of the one or more resolution processes, for future records.

19. The non-transitory computer-readable storage medium of claim 17, wherein retrieving the one or more information using the RAG engine, comprises:
obtaining the one or more first inputs from the one or more electronic devices associated with the one or more first users;
extracting one or more vector representations corresponding to the one or more first inputs, using the RAG engine;
comparing the one or more vector representations corresponding to the one or more first inputs, with one or more pre-stored vector representations; and
retrieving the one or more information from the one or more external sources, based on the comparison of the one or more vector representations corresponding to the one or more first inputs, with the one or more pre-stored vector representations, using a multi-tenant vector search architecture.

20. The non-transitory computer-readable storage medium of claim 17, further comprising generating one or more prompts for the ML model for generating the one or more responses, using the optimized one or more information, wherein the one or more prompts comprise one or more fields corresponding to the optimized one or more information, comprising at least one of: a context comprising roles and guidelines of the one or more first users, user information comprising at least one of: name, account identity, and user identity of the one or more first users, one or more instructions comprising one or more rules for formatting and generating the one or more responses, one or more sample details indicating an interaction that demonstrates a desired format, a response format comprising a pre-defined data structure for the output, one or more documents comprising one or more contextually relevant information retrieved from a vector store, and conversation history.
